(19) United States
(12) Patent Application Publication
(10) Pub. No.: US 2011/0196641 A1
(43) Pub. Date: Aug. 11, 2011

(54) Semiconductor device and diagnostic method thereof

(75) Inventor: Yasunori Sawai, Kanagawa (JP)

(73) Assignee: Renesas Electronics Corporation, Kawasaki (JP)

(21) Appl. No.: 12/929,590

(22) Filed: Feb. 2, 2011

(30) Foreign Application Priority Data
Feb. 8, 2010 (JP) 2010-025153

(51) Int. Cl. G06F 19/00

(52) U.S. Cl. 702/117

(57) ABSTRACT

A semiconductor device includes a test target circuit subjected to self-diagnosis, a PLL circuit that outputs a clock for the self-diagnosis to the test target circuit, a diagnostic register that stores a clock frequency corresponding to an operation speed limit of the test target circuit, and a control circuit that sets a frequency of the clock output from the clock circuit based on the clock frequency stored in the diagnostic register when executing the self-diagnosis.

### CROSS-REFERENCE TO RELATED APPLICATIONS

The disclosure of Japanese Patent Application No. 2010-25153 filed on Feb. 8, 2010 including the specification, drawings and abstract is incorporated herein by reference in its entirety.

### BACKGROUND

1. Field of the Invention

The present invention relates to a semiconductor device, and a diagnostic method thereof, and more particularly, the present invention relates to a semiconductor device with a self-diagnostic function and a diagnostic method thereof.

2. Description of the Related Art

Recently, a microcomputer with a self-diagnostic function has been employed. The microcomputer executes the self-diagnosis of functional blocks. For example, the self-diagnosis is executed when supplying power to the semiconductor device to ensure detection of the microcomputer's failure.

Japanese Unexamined Patent Publication No. 2003-68865 discloses the self-diagnostic method using a Built In Self Test (BIST) circuit. Specifically, the self-diagnostic method disclosed in Japanese Unexamined Patent Publication No. 2003-68865 uses a BIST controller for transmitting diagnostic conditions, based on which respective functional blocks are diagnosed.

### SUMMARY

There is the following problem in the self-diagnostic method as disclosed in Japanese Unexamined Patent Publication No. 2003-68865. That is, the self-diagnosis is executed at a predetermined operation frequency in the above-disclosed self-diagnostic method, which may cause misjudgment that the device with operation margin is normally operated even if it has been deteriorated since the shipment. If the deterioration is within the operation margin, the device will be judged as being normally operated, and accordingly, it is difficult for the above-disclosed diagnostic method to execute appropriate diagnosis.

The present invention seeks to solve one or more of the above problems, or to improve upon those problems at least in part.

The present invention provides a semiconductor device which includes a target circuit subjected to self-diagnosis, a clock circuit that outputs a clock for the self-diagnosis to the target circuit, a data storage unit that stores a clock frequency corresponding to an operation speed limit of the target circuit, and a control unit that sets a frequency of the clock output from the clock circuit when executing the self-diagnosis based on the clock frequency stored in the data storage unit. The aforementioned structure allows the diagnosis at the clock frequency corresponding to the operation speed limit, resulting in appropriate diagnosis.

The present invention provides a method of diagnosing a semiconductor device. The method includes setting a clock frequency corresponding to an operation speed limit of a target circuit subjected to self-diagnosis, and diagnosing the target circuit using a clock signal at the clock frequency corresponding to the operation speed limit. The method allows the diagnosis at the clock frequency corresponding to the operation speed limit, resulting in appropriate diagnosis.

The present invention provides the semiconductor device capable of executing the diagnosis appropriately and the diagnostic method thereof.

### BRIEF DESCRIPTION OF THE DRAWINGS

The above and other purposes, advantages and features of the present invention will become more apparent from the following description of certain exemplary embodiments taken in conjunction with the accompanying drawings in which:

FIG. 1 is a block diagram illustrating a structure of a semiconductor device according to a first exemplary embodiment of the present invention;

FIG. 2 is a flowchart of a setting process at shipment in a diagnostic method of the semiconductor device according to the first exemplary embodiment of the present invention;

FIG. 3 is a flowchart representing the diagnostic method of the semiconductor device according to the first exemplary embodiment of the present invention;

FIG. 4 is an explanatory view of a circuit operation of a register;

FIG. 5 is a block diagram illustrating a structure of a semiconductor device according to a second exemplary embodiment of the present invention; and

FIG. 6 is a flowchart representing a diagnostic method of the semiconductor device according to the second exemplary embodiment of the present invention.

### DETAILED DESCRIPTION OF THE EXEMPLARY EMBODIMENTS

Exemplary Embodiments according to the present invention will be described in detail referring to the drawings. For clear understanding of the explanation, the following description and the drawings are arbitrarily simplified.

### First Exemplary Embodiment

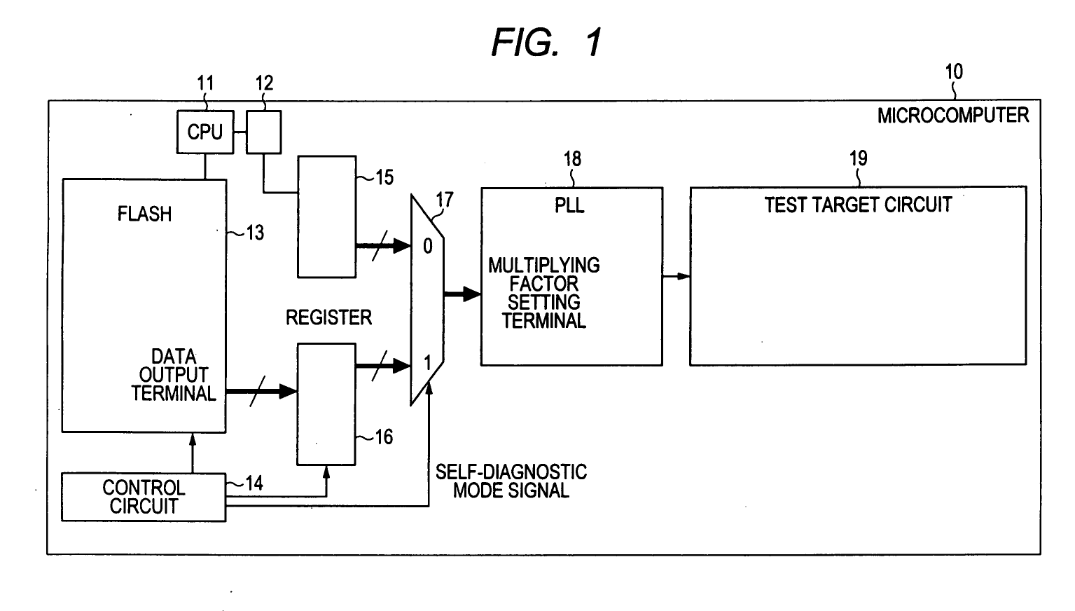

A semiconductor device according to a first exemplary embodiment of the present invention will be described referring to FIG. 1. FIG. 1 is a block diagram illustrating a circuit structure of a microcomputer as the semiconductor device according to the first exemplary embodiment. A microcomputer 10 shown in FIG. 1 includes a self-diagnostic function. That is, the microcomputer 10 is realized by a semiconductor chip with the self-diagnostic function. For example, when power is supplied, the microcomputer 10 executes the self-diagnosis to determine whether or not failure has occurred. In this way, the microcomputer 10 is structured as an Integrated Circuit (IC) with the self-diagnostic function. The microcomputer 10 may be formed as a BIST circuit.

The microcomputer 10 includes a CPU 11, a general-purpose register 12, a flash memory 13, a control circuit 14, a normal operation register 15, a diagnostic register 16, a selector 17, a PLL circuit 18, and a test target circuit 19.

The test target circuit 19 is a functional block subjected to the self-diagnosis. For example, the test target circuit 19 is subjected to the self-diagnosis when starting the microcomputer 10. After the self-diagnosis of the test target circuit 19, it is normally operated. The test target circuit 19 is designed to perform the predetermined function in a non-diagnostic state where the self-diagnosis is not executed. Referring to FIG. 1, one test target circuit 19 is built in the microcomputer 10. However, two or more test target circuits 19 may be used as the respective functional blocks. That is, two or more functional blocks may be built in the microcomputer 10, each of which is subjected to the diagnosis as the individual test target circuit 19.

In execution of the self-diagnosis, diagnostic data is input into the test target circuit 19, for example. An actual output value corresponding to the input data is compared with an estimated value corresponding to the input. That is, the output value corresponding to the input data in the normal state is set as the estimated value. The diagnosis is executed by determining whether or not the estimated value is equal to the actual output value. If the actual output value coincides with the estimated value, it is determined that the test target circuit 19 normally functions. If the actual output value does not coincide with the estimated value, it is determined that the test target circuit 19 abnormally functions.

The PLL circuit 18 supplies a clock to the test target circuit 19 by executing a PLL (Phase Locked Loop) operation. That is, a signal serving as a reference frequency is input into the PLL circuit 18. The PLL circuit 18 then outputs a clock signal in synchronization with the signal as the reference frequency. In this way, the PLL circuit 18 becomes a clock circuit for generating the clock.

The test target circuit 19 is operated based on the clock signal supplied from the PLL circuit 18. The self-diagnosis is executed based on the clock supplied from the PLL circuit 18. It is then determined whether or not the test target circuit 19 has been deteriorated. In a non-diagnostic state, the normal operation is performed based on the clock signal supplied from the PLL circuit 18. The test target circuit 19 as the functional block performs the designed function, and accordingly, it is normally operated. The PLL circuit 18 includes a multiplying factor setting terminal. In accordance with the signal input into the multiplying factor setting terminal, the multiplying factor with respect to the reference frequency is set. According to the first exemplary embodiment, the multiplying factor varies depending on the diagnostic state and the normal operation (non-diagnostic) state. That is, based on the signal input into the multiplying factor setting terminal, the PLL circuit 18 outputs the different clock frequency. The PLL circuit 18 generates the clock at the frequency in accordance with the usage so as to be output to the test target circuit 19.

The CPU 11 executes arithmetic processing for operating the microcomputer 10 by controlling the memory and the functional block. This allows the microcomputer 10 to perform the predetermined operation. For example, the CPU 11 executes the arithmetic processing for running the program stored in the flash memory 13. The CPU 11 outputs the arithmetic result to the test target circuit 19, which is the functional block. In normal operation, the functional block executes the predetermined processing.

The general-purpose register 12 stores the normal operation frequency and the like, and further the value corresponding to the clock frequency in the normal operation (non-diagnostic) state. Specifically, the multiplying factor corresponding to the clock frequency in the normal operation state is stored in the general-purpose register 12. It is assumed that the clock frequency in the normal operation (non-diagnostic) state is defined as a normal operation clock frequency. The general-purpose register 12 stores the multiplying factors corresponding to the normal operation clock frequency and the reference frequency, respectively. It is assumed that the multiplying factor corresponding to the normal operation clock frequency is defined as a normal operation multiplying factor. The normal operation multiplying factor stored in the general-purpose register 12 may be used for setting not only the clock frequency in the test target circuit 19 but also the clock frequency for another functional block. The normal operation clock frequency stored in the general-purpose register 12 is stored in the normal operation register 15. The general-purpose register 12 may be built in the CPU 11.

The flash memory 13 is nonvolatile, and stores program and data for allowing the microcomputer 10 to execute predetermined operations. The program and data stored in the flash memory 13 are read by the CPU 11. The flash memory 13 stores setting data for setting the clock frequency in diagnosis (diagnostic clock frequency). For example, the flash memory 13 has a region set for storing the diagnostic clock frequency. The flash memory 13 includes a data output terminal for outputting the setting data. The diagnostic clock frequency stored in the flash memory 13 is stored in the diagnostic register 16. Specifically, the flash memory 13 has the region set for storing the multiplying factor corresponding to the diagnostic clock frequency. The flash memory 13 outputs the multiplying factor to the diagnostic register 16. The diagnostic register 16 stores the multiplying factor (hereinafter referred to as the diagnostic multiplying factor) corresponding to the diagnostic clock frequency.

The selector 17 selects one of a clock frequency from the normal operation clock frequency stored in the normal operation register 15 and the diagnostic clock frequency stored in the diagnostic register 16. The selector 17 outputs the selected clock frequency to the PLL circuit 18. Specifically, the selector 17 selects one of the multiplying factor for the normal operation stored in the normal operation register 15 and the multiplying factor for diagnosis stored in the diagnostic register 16. The selected multiplying factor is output to the multiplying factor setting terminal of the PLL circuit 18.

The control circuit 14 controls selection operations performed by the selector 17. The control circuit 14 outputs a self-diagnosis mode signal for executing the self-diagnosis. Upon reception of the self-diagnosis mode signal output from the control circuit 14, the selector 17 selects an appropriate multiplying factor so as to be output to the PLL circuit 18. That is, in accordance with the self-diagnosis mode signal, the selector 17 selects one of the diagnostic multiplying factor and the normal operation multiplying factor, and outputs the selected multiplying factor to the multiplying factor setting terminal of the PLL circuit 18. Based on the self-diagnosis mode, one of the self-diagnosis mode for executing the self-diagnosis and the normal operation mode for executing the normal operation is selected.

The control circuit 14 further controls setting of the diagnostic multiplying factor for each IC chip, for example. Specifically, the suitable diagnostic multiplying factor is measured for each chip at shipment of the respective chips. The clock frequency corresponding to the operation speed limit is detected for each chip, and the self-diagnosis is executed at the detected clock frequency, resulting in even more appropriate diagnosis.

The value of the diagnostic multiplying factor is different from that of the normal operation multiplying factor. Specifically, the diagnostic multiplying factor is set to be larger than the normal operation multiplying factor. This makes it possible to detect the deteriorated state of the microcomputer 10 before its failure. In other words, as the value of the diagnostic multiplying factor is large, abnormality may be detected before the failure in spite of the operation margin of the clock frequency for normally operating the microcomputer 10. That is, deterioration can be detected before reveal of the operation abnormality at the operation speed in the normal operation mode.

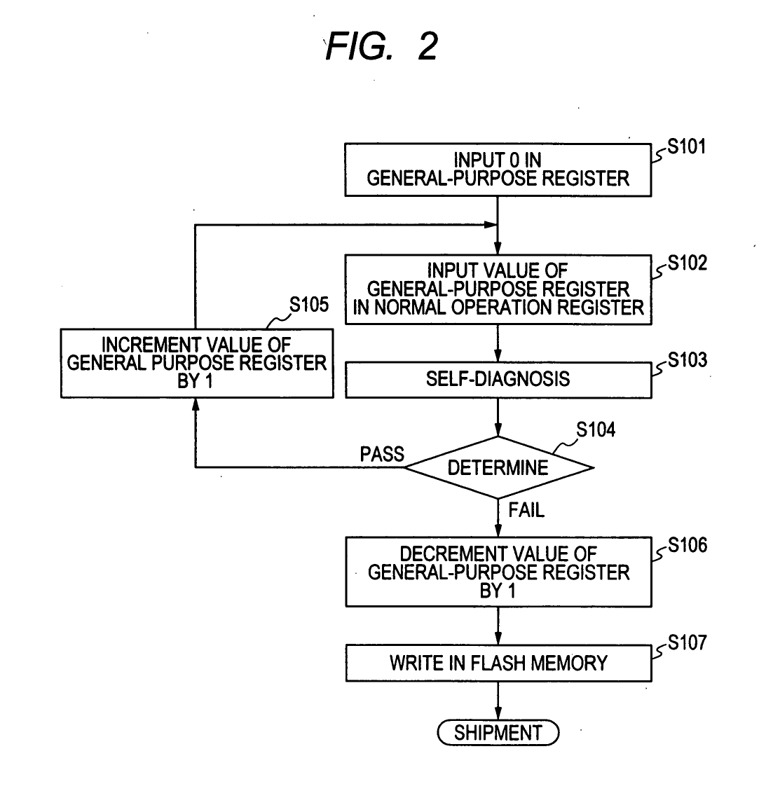

Referring to FIG. 2, the diagnostic method according to the first exemplary embodiment will be described. FIG. 2 is a flowchart representing the process for setting the multiplying factor in the diagnostic method. The process shown in FIG. 2 is executed for each chip at shipment thereof, for example. This makes it possible to set the optimum multiplying factor for each chip. That is, the process shown in FIG. 2 is executed for setting the clock frequency corresponding to the operation speed limit for each chip. The clock frequency corresponding to the operation speed limit is set as the diagnostic clock frequency.

In step S101, “0” is input into the general-purpose register 12. Then in step S102, the value in the general-purpose register 12 is input into the normal operation register 15 which receives the input value of “0”. This value corresponds to the multiplying factor of 1, that is, the reference frequency. In step S103, the self-diagnosis is executed, and the reference frequency is input into the test target circuit 19 from the PLL circuit 18. The test target circuit 19 executes the diagnosis at the reference frequency. The diagnostic data is input into the test target circuit 19. Then the output of the diagnostic data and the estimated value are compared. At this time, the test target circuit 19 executes the diagnostic operation at the reference frequency.

Based on the self-diagnostic result, it is determined whether or not the test target circuit 19 is normally operated in step S104. That is, the output value corresponding to the input diagnostic data and the estimated value are compared. If the output value coincides with the estimated value, that is, the output has the designed value, it is determined that the test target circuit 19 has been normally operated at the clock frequency, and PASS is obtained. If the output value does not coincide with the estimated value, that is, the output does not have the designed value, it is determined that the test target circuit 19 has not been normally operated at the clock frequency, and FAIL is obtained.

If PASS is obtained, the value in the general-purpose register 12 is incremented in step S105. Then the value in the general-purpose register 12 is incremented by 1. The process returns to step S102 where the same processing (steps S103, S104) is executed. That is, the diagnostic process is executed by increasing the multiplying factor of the clock frequency. Then self-diagnosis of the test target circuit 19 is executed at the frequency higher than the clock frequency determined as PASS. The value in the general-purpose register 12 is incremented until FAIL is obtained. That is, the multiplying factor is gradually increased until the test target circuit 19 is no longer normally operated.

If FAIL is obtained, the value in the general-purpose register 12 is decremented by 1 in step S106. Then the decremented value is written in the flash memory 13 in step S107. The highest multiplying factor determined as PASS is written in the flash memory 13. The highest multiplying factor becomes the one corresponding to the clock frequency at the operation speed limit. That is, the multiplying factor corresponding to the diagnostic clock frequency is stored in the flash memory 13. When the diagnostic clock frequency is determined, the shipment is ready. In this way, the multiplying factor corresponding to the operation speed limit may be measured for each chip.

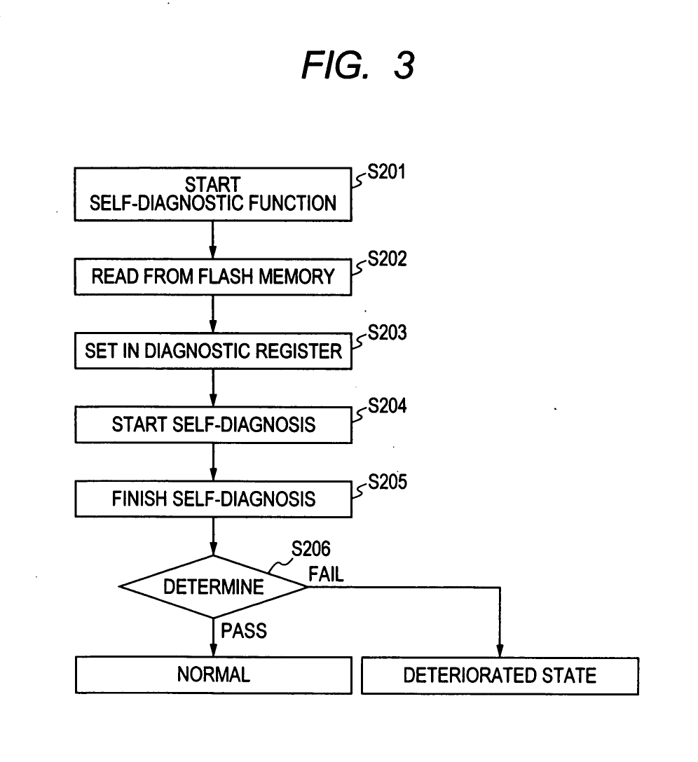

A diagnostic operation after shipment will be described referring to FIG. 3. FIG. 3 is a flowchart representing the diagnostic processing. In step S201, the self-diagnostic function is activated upon start of the microcomputer 10. Then the control circuit 14 reads the diagnostic multiplying factor stored in the flash memory 13 in step S202, and the value is set in the diagnostic register 16 in step S203. Then the multiplying factor corresponding to the clock frequency at the operation speed limit set in the flow at shipment is stored in the diagnostic register 16. The self-diagnosis is then started in step S204. The PLL circuit 18 outputs the diagnostic clock frequency to the test target circuit 19. That is, the selector 17 selects the diagnostic multiplying factor in accordance with the self-diagnosis mode signal from the control circuit 14, as shown in FIG. 1. Accordingly, the diagnostic multiplying factor is input into the multiplying factor setting terminal of the PLL circuit 18. The PLL circuit 18 then outputs the clock signal at the diagnostic clock frequency to the test target circuit 19.

When the self-diagnosis is finished in step S205, the determination is made in step S206 with respect to PASS/FAIL based on the result. If PASS is obtained as a determination result of the self-diagnosis, it is determined that the subject device is normally operated. If FAIL is obtained as the determination result of the self-diagnosis, it is determined that the subject device has been in a deteriorated state. In spite of the clock frequency determined as PASS at the shipment, the subject device has been deteriorated as it is used, and may be determined as FAIL. This makes it possible to detect the deteriorated state before the failure. That is, the determination may be made with respect to the deteriorated state of the subject device before it becomes inoperative at the normal operation clock frequency. The deterioration before failure may be detected so as to appropriately diagnose the test target circuit 19.

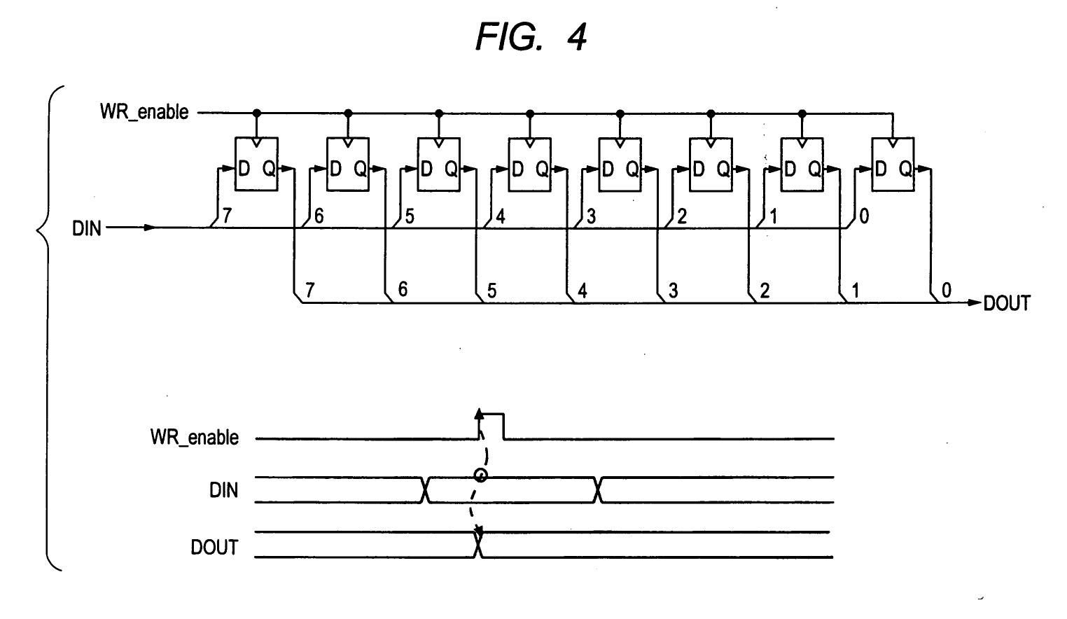

The timing for writing data in the diagnostic register 16 will be described referring to FIG. 4. FIG. 4 represents a circuit diagram and a timing chart for explaining the writing operation in the diagnostic register 16. Referring to FIG. 4, the circuit diagram is shown at the upper side and the timing chart is shown at the lower side. FIG. 4 illustrates an example of the 8-bit operation of the diagnostic register 16. Input data DIN output from the data output terminal of the flash memory 13 is written in the diagnostic register 16 in accordance with a write enable signal WR_enable from the control circuit 14. The value of the input data DIN having the write enable signal WR_enable output at a timing H is written in the diagnostic register 16. The data written in the diagnostic register 16 is output to the selector 17 as output data DOUT. As the process for writing in the normal operation register 15 is the same as the one for the diagnostic register 16, and explanation of the process will be omitted. The write enable signal WR_enable from the CPU 11 or the general-purpose register 12 and the input data DIN are input into the normal operation register 15.

The control circuit 14 built in the chip reads the multiplying factor of the built-in flash memory 13 before executing the self-diagnosis, and the read multiplying factor is stored in the diagnostic register 16. The multiplying factor data stored in the diagnostic register 16 is selected upon start-up of the self-diagnosis mode, and supplied to the multiplying factor setting terminal of the PLL circuit 18. The self-diagnosis is executed at the clock frequency with the supplied multiplying factor. The failure owing to deterioration which occurs after prolonged use of the product may be detected beforehand at the stage where the system operation is ensured. This makes it possible to maintain the system in safe state. Detection with respect to increase in the current owing to failure may also be improved. The deteriorated state may be detected just before breakage of the element owing to failure, thus preventing short-circuit caused by the failure.

### Second Exemplary Embodiment

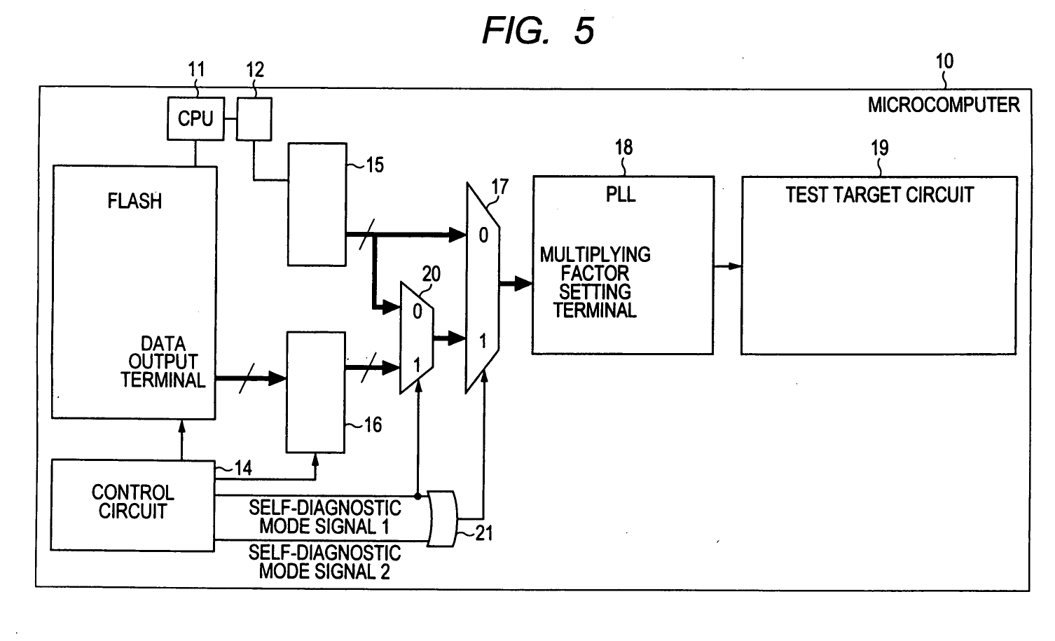

A semiconductor device according to a second exemplary embodiment will be described referring to FIG. 5. FIG. 5 is a block diagram illustrating a structure of the microcomputer 10 as the semiconductor device according to the second exemplary embodiment. The microcomputer 10 illustrated in FIG. 5 has substantially the same basic structure as that of the microcomputer 10 according to the first exemplary embodiment. In the second exemplary embodiment, explanation of the components common to those of the first exemplary embodiment will be omitted.

The second exemplary embodiment is formed by adding a selector 20 and an OR circuit 21 to the structure of the microcomputer 10 according to the first exemplary embodiment. The control circuit 14 outputs two self-diagnosis mode signals. It is assumed that one of the two self-diagnosis mode signals is set as a self-diagnosis mode signal 1 and the other is set as a self-diagnosis mode signal 2. The rest of the structure is the same as the first exemplary embodiment, and explanation thereof, thus will be omitted.

Like the first exemplary embodiment, the self-diagnosis mode signal 1 is used for executing the self-diagnostic test at the operation speed limit frequency. This mode is defined as a self-diagnosis mode 1. Meanwhile, the self-diagnosis mode signal 2 is used for executing the self-diagnostic test at the normal operation frequency. This mode is defined as a self-diagnosis mode 2. For example, if the self-diagnostic test is conducted at the operation speed limit frequency, the self-diagnosis mode signal 1 is set as H, and the self-diagnosis mode signal 2 is set as L. Meanwhile, if the self-diagnostic test is conducted at the normal operation frequency, the self-diagnosis mode signal 1 is set as L, and the self-diagnosis mode signal 2 is set as H. In the non-diagnostic state where the self-diagnosis is not executed, that is, in the normal operation state, both the self-diagnosis mode signals 1 and 2 are set as L.

When executing the self-diagnosis as described above, the control circuit 14 outputs the self-diagnosis mode signal 1 or the self-diagnosis mode signal 2. The self-diagnosis mode signal 1 from the control circuit 14 is input into the selector 20. The selector 20 receives input values of the multiplying factors from the normal operation register 15 and the diagnostic register 16, respectively. The selector 20 outputs the multiplying factor corresponding to the operation speed limit frequency from the diagnostic register 16 when the self-diagnosis mode signal 1 is set as H, and outputs the multiplying factor corresponding to the normal operation frequency from the normal operation register 15 when the self-diagnosis mode signal 1 is set as L. The multiplying factor from the selector 20 is input into the selector 17.

The self-diagnosis mode signals 1 and 2 from the control circuit 14 are input into the OR circuit 21. If at least one of the self-diagnosis mode signals 1 and 2 is set as H, the OR circuit 21 outputs the signal H to the selector 17. If both the self-diagnosis mode signals 1 and 2 are set as L, the OR circuit 21 outputs the signal L to the selector 17. The selector 17 receives inputs of the multiplying factors from the selector 20 and the multiplying factor from the normal operation register 15. When the signal from the OR circuit 21 is set as H, the selector 17 outputs the multiplying factor from the selector 20 to the PLL circuit 18. Then the PLL circuit 18 is operated at the multiplying factor for the diagnosis. That is, the clock is set at the operation limit speed frequency or the normal operation frequency so as to execute the self-diagnosis appropriately. When the signal from the OR circuit 21 is set as L, the selector 17 outputs the multiplying factor from the normal operation register 15 to the PLL circuit 18. That is, the clock is set at the normal operation frequency.

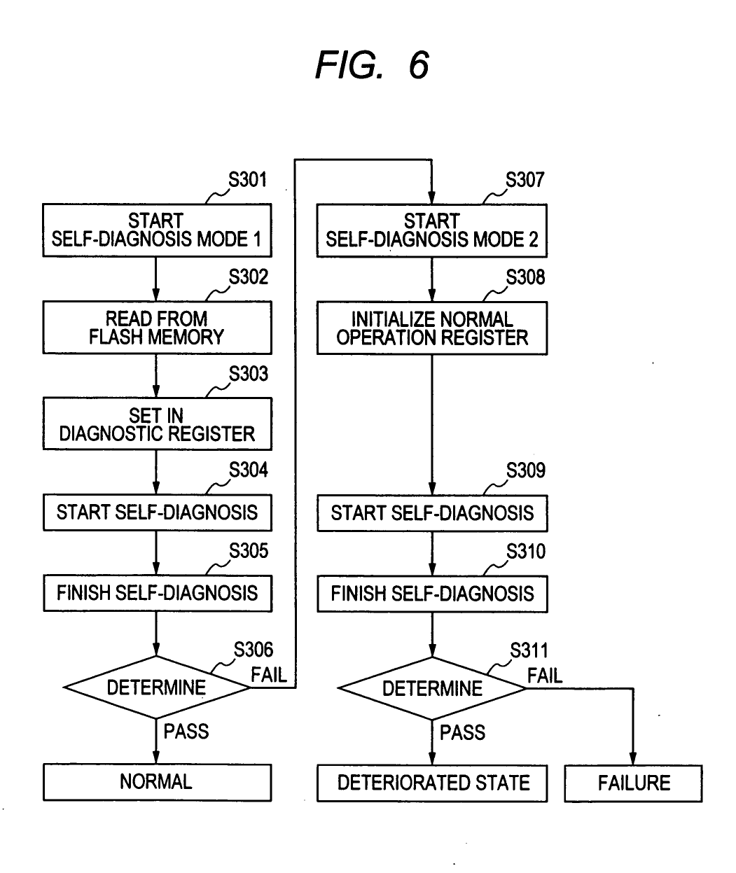

The self-diagnostic method according to the second exemplary embodiment will be described referring to FIG. 6. FIG. 6 is a flowchart representing the diagnostic procedure. In the second exemplary embodiment, explanation of the same process as that of the first exemplary embodiment will be omitted. Setting of the operation limit speed frequency upon shipment is the same as represented by the flow of the first exemplary embodiment represented by FIG. 2.

The self-diagnosis mode 1 is started using the self-diagnosis mode signal 1 in step S301 for executing the diagnosis at the operation limit speed frequency. Then the multiplying factor is read from the flash memory 13 in step S302. In step S303, the control circuit 14 sets the read multiplying factor in the diagnostic register 16. In the aforementioned state, the self-diagnosis is started in step S304. The self-diagnosis is executed at the operation limit speed frequency. In step S305, the self-diagnosis is finished. The determination with respect to PASS/FAIL is executed in step S306. That is, the estimated value and the output value with respect to the diagnostic data are compared. If the estimated value coincides with the output value, PASS is obtained, and it is determined as being normal. In this case, the device is operated at the operation limit speed with no problem. The device has hardly been deteriorated since the shipment, and it is determined that the device is normally operated.

If FAIL is obtained, the self-diagnosis mode 2 is started using the self-diagnosis mode signal 2 in step S307 for executing the diagnosis at the normal operation frequency. Then the normal operation register 15 is initialized. This allows the general-purpose register 12 to write the normal operation frequency in the normal operation register 15. In the aforementioned state, the self-diagnosis is started in step S309. The self-diagnosis is executed at the normal operation frequency. When the self-diagnosis is finished in step S310, the PASS/FAIL determination is made in step S311. That is, the estimated value and the output value with respect to the diagnostic data are compared. If the estimated value coincides with the output value, PASS is obtained as the determination result. In this case, it is determined that the test target circuit 19 is in the deteriorated state. That is, the subject device cannot be normally operated at the operation limit speed, but it is normally operated at the normal operation speed. It is determined that the subject device has been in the deteriorated state since the shipment, which is within the operation margin. It is therefore determined as in the deteriorated state. Meanwhile, if the estimated value does not coincide with the output value, FAIL is obtained as the determination result. In this case, it is determined that failure has occurred in the test target circuit 19. That is, it cannot be normally operated at the normal operation frequency, and therefore, the test target circuit 19 is determined as having failure.

Execution of the self-diagnosis ensures detection of the deteriorated state before the failure, thus allowing the appropriate action to be taken to the deteriorated functional block. That is, the action may be taken to the block in the deteriorated state before the failure, resulting in improved reliability.

In the second exemplary embodiment, two clock frequency values are used for executing the diagnosis. However, three or more clock frequency values may be used for executing the diagnosis. For example, the operation speed limit frequency, the normal operation frequency, and a frequency therebetween may be used. Specifically, three values of the multiplying factor are set so that one of them is selected based on the self-diagnosis mode signals 1 to 3. This makes it possible to determine with respect to the normally operable frequency in stages, thus detecting advancement of deterioration.

### Other Exemplary Embodiments

In the first and the second exemplary embodiments, the multiplying factor corresponding to the clock frequency is stored in the respective registers. The value of the clock frequency may be directly stored. Alternatively, each register may be structured to store the value corresponding to the clock frequency. That is, the value other than the multiplying factor may be stored in the flash memory 13 for the purpose of storing the diagnostic clock frequency corresponding to the operation speed limit. The frequency or the multiplying factor may be stored in a memory unit other than the register. The general-purpose register 12 and the normal operation register 15 are separately provided. However, the same register may be used.

The frequency corresponding to the operation limit speed is measured before shipment. The frequency measured for each chip is stored in the flash memory 13 built in the chip. This makes it possible to execute appropriate diagnosis in spite of each difference among the devices. In other words, this makes it possible to execute appropriate diagnosis for each chip.

Although the invention has been described above in connection with several exemplary embodiments thereof, it will be appreciated by those skilled in the art that those exemplary embodiments are provided solely for illustrating the invention, and should not be relied upon to construe the appended claims in a limiting sense.

Further, it is noted that, notwithstanding any claim amendments made hereafter, applicant's intent is to encompass equivalents all claim elements, even if amended later during prosecution.

What is claimed is:

1. A semiconductor device comprising:
a target circuit subjected to self-diagnosis;
a clock circuit that outputs a clock for the self-diagnosis to the target circuit;
a data storage unit that stores a clock frequency corresponding to an operation speed limit of the target circuit; and
a control unit that sets a frequency of the clock output from the clock circuit when executing the self-diagnosis based on the clock frequency stored in the data storage unit.

2. The semiconductor device according to claim 1, wherein the target circuit is normally operated in a non-diagnostic state at a clock frequency lower than the clock frequency stored in the data storage unit.

3. The semiconductor device according to claim 1,
wherein the clock circuit is a PLL circuit, and
wherein the data storage unit stores a multiplying factor of the PLL circuit.

4. The semiconductor device according to claim 1, wherein the data storage unit stores two or more frequency values for executing the self-diagnosis.

5. A method of diagnosing a semiconductor device comprising:
setting a clock frequency corresponding to an operation speed limit of a target circuit subjected to self-diagnosis; and
diagnosing the target circuit using a clock signal at the clock frequency corresponding to the operation speed limit.

6. The method according to claim 5, wherein the target circuit is normally operated in a non-diagnostic state at a clock frequency lower than the clock frequency corresponding to the operation speed limit.

7. The method according to claim 5,
wherein a multiplying factor of the clock frequency corresponding to the operation speed limit is set, and
wherein a clock of the frequency corresponding to the operation limit speed is supplied to the target circuit by supplying the multiplying factor to a PLL circuit for generating the clock.

8. The method according to claim 5, wherein diagnosis is executed by changing a frequency for the self-diagnosis.

9. The method according to claim 5,
wherein the clock frequency corresponding to the operation limit speed is measured before shipment of the semiconductor device, and
wherein the diagnosis is executed at the clock frequency corresponding to the operation limit speed after the shipment to detect deterioration of the semiconductor device after the shipment.
